(19) United States
(12) Patent Application Publication
(10) Pub. No.: US 2004/0241462 A1
(43) Pub. Date: Dec. 2, 2004

(54) Substrate for immobilizing physiological material, and a method of preparing the same

(76) Inventors: In-Ho Lee, Yongin-city (KR); Kang-Il Seo, Suwon-city (KR); Jin-Iee Lee, Seoul (KR); Hun-Soo Kim, Seoul (KR)

Correspondence Address: CHRISTIE, PARKER & HALE, LLP, PO BOX 7068, PASADENA, CA, 91109-7068, US

(21) Appl. No.: 10/747,661

(22) Filed: Dec. 29, 2003

(30) Foreign Application Priority Data
Jun. 2, 2003 (KR) 2003-0035427

(51) Int. Cl. B32B 15/08; B05D 1/38

(52) U.S. Cl. 428/447; 428/448; 428/450; 427/402; 427/425; 427/430.1; 427/443.1

(57) ABSTRACT

Disclosed is a substrate construction for immobilizing a physiological material that has a substrate; an organic polymer linker material layer formed on the substrate; and a gold thin layer formed on the organic polymer linker material layer. The organic polymer linker material layer has a thickness ranging form 30 to 200 nm and shows peaks of 111 and 200 planes using X-ray diffractometry when the X-rays radiate at an incident angle of 1.5. The substrate is prepared through the processes of forming an organic polymer linker material layer by coating a coating composition including organic polymer linker material on a substrate; forming a seed colloid catalytic layer by coating a gold colloid dispersion on the organic polymer linker material layer; drying or heat-treating the substrate on which the seed colloid catalytic layer is formed; and obtaining a gold thin layer by coating a coating composition that includes a gold salt-containing aqueous solution and a reducing agent-containing solution.

### CROSS-REFERENCE TO RELATED APPLICATION

This application claims priority of Korean Patent Application No. 2003-35427 filed on Jun. 2, 2003 in the Korean Intellectual Property Office, the entire disclosure of which is incorporated herein by reference.

### BACKGROUND OF THE INVENTION

(a) Field of the Invention

The present invention relates to a substrate construction for immobilizing a physiological material and a method of preparing the same, and more particularly, to a substrate construction for immobilizing a physiological material comprising an organic polymer linker material which fixes a gold thin layer to a substrate and a method of fabricating the same.

(b) Description of the Related Art

In recent times, there has been a rapid worldwide increase in the demand for technology used to analyze the activity of physiological materials such as nucleic acids, proteins, enzymes, antibodies, and antigens. In an effort to meet such a demand, there is suggested a biochip in which the required physiological material molecules are immobilized on specific microscopic regions by adopting semiconductor processing techniques. Such a biochip allows physiologically useful information to be easily obtained simply by biochemically searching the biochip.

The biochip is in the form of a conventional semiconductor chip, but what is integrated thereon is a bio-organic material such as an enzyme, a protein, an antibody, DNA, a microorganism, an animal or plant cell or organ, or a neuron. Depending on its function, the biochip may be classified as a “DNA chip” in the case where it immobilizes a DNA probe; a “protein chip” where it immobilizes a protein such as an enzyme, an antibody, or an antigen; or a “lab-on-a-chip” which is integrated with pre-treating, biochemical reacting, detecting, or data-analyzing functions to impart an auto-analysis function.

To achieve the successful development of such a biochip, it is important to employ a method for immobilizing a physiological material in which an interface between the physiological material and a substrate is efficiently formed, and the inherent functions of the physiological material are fully utilized. Generally, the physiological material is immobilized on the surface of a glass slide, a silicon wafer, a microwell plate, a tube, a spherical bead, a surface with a porous layer, etc. It is of particular importance in the case of a DNA chip or a protein chip that immobilization of physiological material be performed in a limited region, on the scale of micrometers.

A gold substrate has been used as an immobilization substrate for protein, and is prepared using thioctic acid, L-cysteine, mercaptopropyl acid, paraaminothiophene, cysteamine, etc., that includes sulfide or disulfide, which is capable of forming a chemical bond with a gold surface, and that also includes a derivative such as calixarene or cyclodextrine, which has a functional group of —SH, —NH₂, etc., capable of forming a bond with a gold surface at one terminal end and a functional group of —OH, —NH₂, etc., having good affinity with protein at another terminal end. Poly-L-lysine is used for forming the —NH₂ group as a two-dimensional network through a polymer (Biosensors & Bioelectronics, 13, 1213 (1998), Anal Biochem. 272, 66 (1999)).

In order to form a gold surface for immobilization of protein on a substrate such as glass, a silicon wafer, or a plastic substrate, sputtering or evaporation is usually used. However, these methods require precision vacuum equipment that is costly. Therefore, when applied to large-scale production, a very large investment in plant and equipment investment is unavoidable. Further, the bond strength between the gold and substrate is typically weak, and therefore, a metal layer of chromium (Cr), titanium (Ti) or tungsten (W) may be formed before coating the gold on the substrate to enhance the bond strength. However, these metals modify the surface properties of the gold and inhibit electron transfer.

In 1960, Samuel Wein disclosed a gold coating technique (“Gold Films”, The Glass Industry, May 1959 p.280 and June 1959, p.330) in which a dipping or spraying method was used. However, drawbacks of this method include its slow reaction rate and high reaction temperature.

Research has been conducted in the area of autocatalytic gold deposition. For example, U.S. Pat. No. 3,700,469 discloses a method of preparing a gold thin layer using a gold cyanide complex and alkali metal borohydride or dimethylamine borane as a reducing agent. However, the drawbacks of this method include temperature increment requirements for hydrolysis of the reducing agent and the generation of sludge from the autocatalytic decomposition of a gold solution.

Recently, many techniques using a non-cyanide gold complex having a low pH have been developed for use in electronic equipment packaging. Examples may be found in U.S. Pat. Nos. 4,804,559; 5,198,273; 5,202,151; 5,318,621; 5,470,381; 5,935,306. These techniques have been used for electronic equipment such as circuit boards and IC chips. A gold thin layer formed by these techniques has a thickness of about 0.5 to 2 micrometers.

Analysis equipment for biochips such as a protein chip or a DNA chip is used for analyzing interactions between physiological materials using analysis techniques such as laser radiation image interpretation, electrochemical analysis, SPR (Surface Plasmon Resonance), and SELDI-TOF (Surface-Enhanced Laser Desorption/Ionization-Time of Flight). In the case of a gold thin layer substrate, an SPR optical technique and electrochemical analysis are usually used. In order to use these analysis techniques, the gold thin layer must have a thickness of less than 0.1 micrometer. Therefore, the gold thin layer formed by the above patents cannot be analyzed by these analysis techniques.

U.S. Pat. No. 6,168,825 discloses a method of forming a gold thin layer of less than 300 nm using a gold ion solution and a reducing agent. However, sludge generation by autocatalytic decomposition remains a problem with this method. Yongdong Jin (Anal. Chem., 2001, vol 73, 2843-2849) suggests a method for preparing a substrate that may be used in SPR. The method includes forming gold colloid on an aminosilane-coated substrate and forming a gold thin layer using the method of U.S. Pat. No. 6,168,825. However, the SPR characteristics of the substrate are not improved over a substrate prepared by sputtering.

### SUMMARY OF THE INVENTION

In an embodiment of the present invention, a substrate is provided for immobilizing a physiological material in which the substrate construction has an organic polymer linker material layer for enhancing a bond between a gold thin layer and a substrate.

In another embodiment of the present invention, a method is provided for fabricating a substrate construction for immobilizing a physiological material and that has an organic polymer linker material layer for enhancing the bond between a gold thin layer and a substrate.

In still another embodiment of the present invention, a biochip or biosenser is provided comprising a substrate construction for immobilizing a physiological material.

In still another embodiment of the present invention a method is provided for fabricating a substrate construction for immobilizing a physiological material. By this method, an organic polymer linker material layer is formed by coating a coating composition including an organic polymer linker material on a substrate; forming a seed colloid catalytic layer by coating a gold colloid dispersion on the organic polymer linker material layer; drying or heat-treating the layered substrate on which the seed colloid catalytic layer is formed; and obtaining a gold thin layer by coating a coating composition that includes a gold salt-containing aqueous solution and a reducing agent-containing solution.

In yet another embodiment of the present invention, a biochip or biosenser is provided comprising a physiological material immobilized on the surface of the substrate.

One embodiment of the present invention generally provides a substrate construction for immobilizing a physiological material comprising a substrate; an organic polymer linker material layer formed on the substrate; and a gold thin layer formed on the organic polymer linker material layer. The organic polymer linker material layer has a thickness ranging from 30 to 200 nm, and shows peaks at 111 and 200 planes using X-ray diffractometry (XRD) when the X-rays radiate at an incident angle of 1.5°.

Additional aspects and advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a schematic diagram illustrating a substrate construction and a process of fabricating a substrate construction for immobilizing a physiological material according to the present invention;

FIG. 2 is a diagram showing the absorbance of a gold colloid solution;

FIG. 3 is a photograph showing the dispersion of gold particles in a gold colloid solution;

FIG. 4 is a diagram showing the measurement results of surface plasmon resonance with respect to a gold thin layer according to Example 1;

FIG. 5a is a scanning electronic microscope (SEM) photograph of a gold thin layer according to Example 1 (×25000 magnification);

FIG. 5b is an SEM photograph of a gold thin layer according to Example 1 (×50000 magnification);

FIGS. 6a and 6b show acid/base test results with respect to gold thin layers according to Example 1 and Comparative Example 2, respectively; and

FIGS. 7a and 7b show the X-ray diffractometry (XRD) analysis results with respect to gold thin layers according to Example 1 and Comparative Example 1, respectively.

### DETAILED DESCRIPTION

Hereinafter, the present invention is described in further detail.

A substrate construction for immobilizing a physiological material of the present invention comprises an organic polymer linker material layer formed on a substrate and a gold thin layer formed on the organic polymer linker material layer. The substrate may be a transparent solid substrate or an opaque solid substrate such as a silicon wafer. Preferably, environmentally stable or chemical-resistant glass, polycarbonate, polyester, polyethylene (PE), polypropylene (PP), or a silicon wafer may be used for the substrate. However, the present invention is not limited to these materials.

One terminal end of the organic polymer linker material has a functional group that is capable of reacting with a functional group of a substrate, and another terminal end has a functional group with a positive charge that is capable of undergoing ionic interaction with a negative charge of a gold colloid surface. The organic polymer linker material may be represented by the formula (1):

X—R₁—Si(R₂)₃ (1)

where X is a functional group having a positive charge that is capable of undergoing ionic interaction with a negative charge of a gold colloid surface, R₁ is a spacer of (CH₂)ₙ or (CH₂)ₙ having one or more carboxyl or imino groups replacing one or more of the ethylene monomers, where n is an integer from 1 to 8, and Si(R₂)₃ is a functional group capable of reacting with functional groups on a substrate surface where each R₂ is an alkoxy group, a halide, or an aldehyde group.

The functional group having a positive charge, X, is preferably an imine group. The organic polymer linker material is preferably a polymer including at least two imine groups.

The functional group capable of reacting with a functional group of a substrate Si(R₂)₃, can be bound with the functional group of the substrate by a covalent bond or bound with a hydrophilic or hydrophobic functional group of the substrate by physicochemical adsorption. In the case where the functional group of the substrate is a hydroxyl group, the organic polymer linker material preferably has a trialkoxysilane group. In addition, the functional group capable of reacting with the functional group of the substrate may be a halide group such as SiCl₃ or an aldehyde group.

The organic polymer linker material may be exemplified by viologen-based compounds having formulas (2a) to (2c), a polymer having an imine group-containing polyethylene backbone having formula (3), a compound having formula (4) or a compound having formula (5).

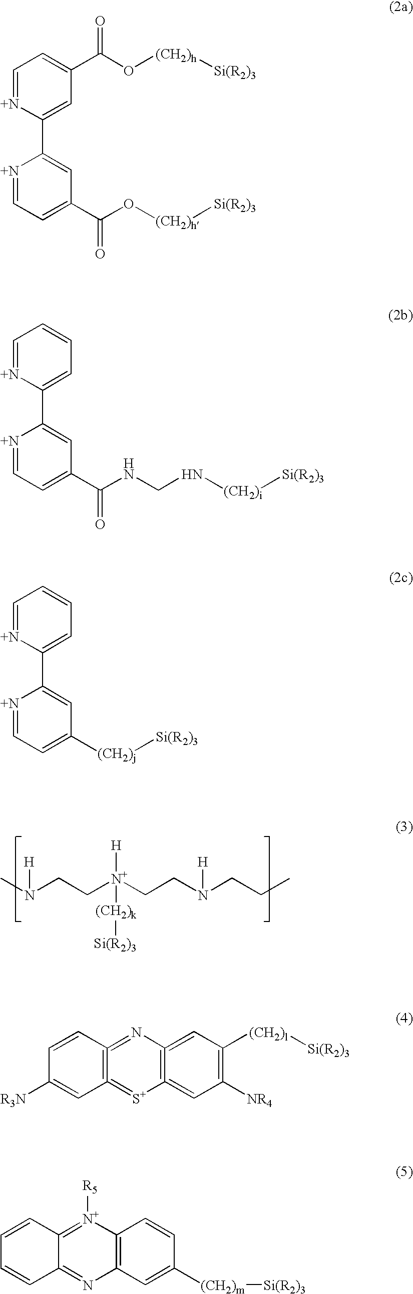

where each R₂ is an alkoxy group, a halide, or an aldehyde group; each of h, h′, l and m is an integer from 1 to 8; R₃ and R₄ are independently (R₆)₂ where R₆ is a halogen or a C₁ to C₆ alkyl; and R₅ is a halogen or a C, to C₆ alkyl.

Preferably, the organic polymer linker material is exemplified by compounds having formulas (2a′) to (2c′), a polymer having formula (3′), a methylene bule compound having formula (4′) or a phenazine methosulphate compound having formula (5′).

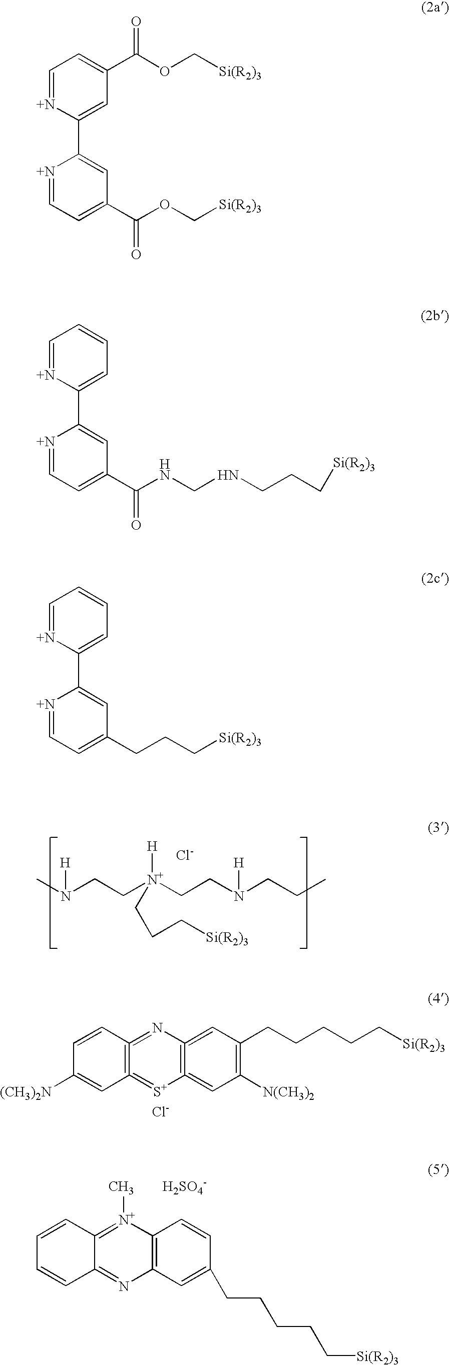

where each R₂ is an alkoxy group, a halide or an aldehyde group. A preferable example of a compound having formula (2′) includes trimethoxysilylpropyl (polyethyleneimine) (PEIM).

The organic polymer linker material layer has a thickness ranging from 5 to 20 nm, preferably 5 to 10 nm. The gold thin layer has a thickness ranging from 30 to 200 nm, preferably 30 to 70 nm, and more preferably 30 to 50 nm.

The gold thin layer shows peaks at 111 and 200 planes using X-ray diffractometry (XRD) when the X-rays radiate at an incident angle of 1.5. The measurement of XRD peaks with respect to the gold thin layer formed on a substrate is performed using a Cu target at a scanning rate of 0.02 degrees/second.

A substrate construction for immobilizing a physiological material of the present invention can immobilize physiological materials using substances such as thioctic acid, L-cysteine, mercaptopropyl acid, paraaminothiophene, and cysteamine. Immobilization of the physiological materials and interactions of physiological materials can be analyzed using biochip analysis techniques such as SPR or an electrochemical method. The substrate comprises a non-metal organic polymer linker material rather than metal such as chromium (Cr), titanium (Ti), or tungsten (W) in order to enhance attachment of the gold thin layer and the organic polymer linker material does not deteriorate the electronic and chemical properties of the gold thin layer. The organic polymer linker material can enhance the attachment of the gold thin layer by binding with gold colloid particles through ionic interaction. The term “physiological material” herein refers to a material derived from an organism or its equivalent, or a material prepared in vitro. Physiological materials include, for example, an enzyme, a protein, an antibody, a microbe, an animal or plant cell or organ, a neuron, DNA, or RNA. Preferably, the physiological material is DNA, RNA, or a protein, where the DNA may include cDNA, genome DNA, or an oligonucleotide; the RNA may include genome RNA, mRNA, or an oligonucleotide; and the protein may include an antibody, an antigen, an enzyme, or a peptide.

A variety of different methods for patterning the physiological material on the immobilization layer may be used such as photolithography, piezoelectric printing, micropipeting, or spotting.

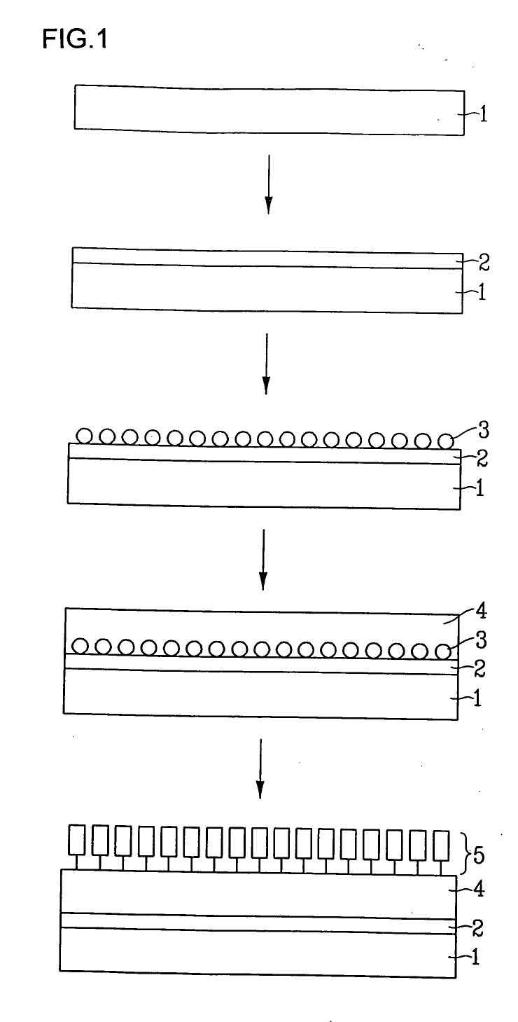

FIG. 1 is a schematic diagram illustrating a process of fabricating a substrate construction for immobilizing a physiological material according to the present invention. First, a washed substrate 1 is coated with a slurry coating composition comprising the organic polymer linker material to form a linker material layer 2. The coating composition is prepared by adding the linker material as described above to a dilution solvent. The dilution solvent is a mixture of water and an organic solvent, and the organic solvent is preferably an alcohol solvent such as methanol, ethanol, propanol, or butanol, a cellosolve solvent, or dimethylformaldehyde.

The coating composition comprises the linker material in an amount from 0.01 to 50 weight %, preferably 0.01 to 10 weight %. In the case where the amount of the material is less than 0.01 weight %, the linking effect is not sufficient, whereas in the case where it is more than 50 weight %, the coated substrate 1 is not uniform.

The linker material layer 2 is prepared by coating the substrate 1 with the coating composition. A wet coating method may be used to coat the substrate 1 with the coating composition. Examples of wet coating methods include, but are not limited to, self-assembly thin layer coating, spin-coating, dipping, spraying, printing, and an LB (Langmuir Blodgett) technique. The linker material layer enhances the attachment between the substrate 1 and a gold seed colloid that is coated on the linker material in the subsequent step and that acts as a seed of an autocatalytic reaction.

The substrate 1 on which the linker material layer 2 is formed is coated with gold colloid dispersion to form a seed colloid catalytic layer 3. The seed colloid catalytic layer 3 comprises gold colloid having a particle size ranging 5 nm to 500 nm.

The gold colloid dispersion comprises gold salt, a reducing agent, a stabilizer, and a solvent. Examples of gold salts include, but are not limited to, a gold chloride such as HAuCl₄ and NaAuCl₄. The concentration of the gold salt preferably ranges from 0.01 mM to 100 mM, more preferably 0.1 mM to 10 mM in consideration of the dispersion properties of the gold colloid particles and to control the gold colloid particle size. If the concentration of the gold salt is more than 100 mM, the mono-dispersion properties of colloid particles deteriorate, whereas if it is less than 0.01 mM, it is not sufficient for forming colloid particles.

Examples of the reducing agent include NaBH₄, thiocyanate, potassium carbonate, trisodium citrate and hydrates thereof, tannic acid, hydroxyamine and salts thereof, and mixtures of these materials. The concentration of the reducing agent preferably ranges from 0.01 mM to 1M, more preferably 0.01 mM to 100 mM. If the concentration of the reducing agent is less than 0.01 mM, desirable gold colloid particles cannot be obtained, whereas if it is more than 1M, the reaction rate is too fast and thus the particle distribution of the gold colloid particles is deteriorated.

An example of a stabilizer is sodium citrate. Examples of solvents include water, methanol, ethanol, propanol, cellosolve-based solvents, and dimethylformamide.

A wet coating method may be used to coat the substrate 1 with gold colloid dispersion. Examples of wet coating methods include, but are not limited to, dipping, spraying, spin-coating, and printing. Preferably, dipping is used as the coating method. When the dipping method is used, a dipping time of 1 minute or more is sufficient for the coating.

The substrate 1 on which seed colloids are absorbed to form the seed colloid catalytic layer 3 is dried or heat-treated. Subsequently, a gold thin layer 4 is formed using autocatalytic deposition, thereby completing the fabrication of a substrate for immobilizing a physiological material. The gold thin layer 4 is formed by coating a mixed composition comprising a gold salt-containing aqueous solution and a reducing agent solution. The gold salt-containing aqueous solution and reducing agent solution are prepared separately and mixed immediately before coating. The gold salt is the same as that is used for preparing a coating composition for forming the seed colloid catalytic layer 3. The concentration of the gold salt ranges from 0.01 weight % to 20 weight %, preferably 0.1 weight % to 10 weight % based on the gold salt-containing aqueous solution. If the concentration of the gold salt is less than 0.01 weight %, a gold thin layer of a desirable thickness cannot be obtained, whereas if it is more than 20 weight %, the thin layer does not have a uniform thickness and an excessive amount of costly gold salt is used.

Examples of the reducing agent include NaBH₄, thiocyanate, potassium carbonate, trisodium citrate or a hydrate thereof, tannic acid, hydroxyamine or a salt thereof, and mixtures of these materials. A hydroxylamine or a salt thereof, or a mixture of two or more of the listed materials is preferable because a uniform thin layer can be obtained by using these reducing agents. The concentration of the reducing agent preferably ranges from 0.01 mM to 1M, more preferably 0.01 mM to 100 mM. If the concentration of the reducing agent is less than 0.01 mM, a desirable thickness of the gold thin layer 4 cannot be obtained, whereas if it is more than 1M, the reaction rate is too fast, thereby making it difficult to control the thickness of the gold thin layer.

An example of a coating method for forming the gold thin layer 4 is a plating method. Preferably, electroless plating is used. The gold salt-containing aqueous solution and the reducing agent solution are mixed in a reaction vessel and the substrate 1 on which seed colloid catalytic layer 3 is formed is dipped and agitated in the reaction vessel to form the gold thin layer 4. There is a linear relation between the thickness of the gold thin layer 4 and the reaction time. As a result, a desirable thickness of the gold thin layer 4 is obtained by dipping the substrate 1 in the reaction vessel for a predetermined time. In order to obtain desirable SPR properties, it is preferable that the substrate 1 be dipped for about 10 minutes. The plating method can control the thickness of the gold thin layer 4 to a desirable level on the scale of nanometers. Physiological matter 5 is then immobilized on the gold thin layer 4 by methods well known in the art, thereby forming a biochip.

Using the method of the present invention described above, a large-scale substrate may be manufactured at a low cost since a large investment in costly equipment such as vacuum deposition equipment is unneeded.

Hereinafter, the present invention will be explained in detail with reference to examples. These examples, however, should not in any sense be interpreted as limiting the scope of the present invention.

### EXAMPLE 1

### 1-1 Preparation of Gold Colloid Dispersion

1 ml of a 1% HAuCl₄.3H₂O aqueous solution was added to 100 ml of demineralized water. This mixture was then heated while agitating the same. The mixture was heated until it started to boil then was left in this state for 6 minutes. Next, 2 ml of a 1% sodium citrate aqueous solution, and 0.45 ml of a 1% tannic acid aqueous solution were simultaneously added to the mixture then left to react. After agitating for 1 minute, the reaction mixture was cooled at room temperature and stored at 4° C.

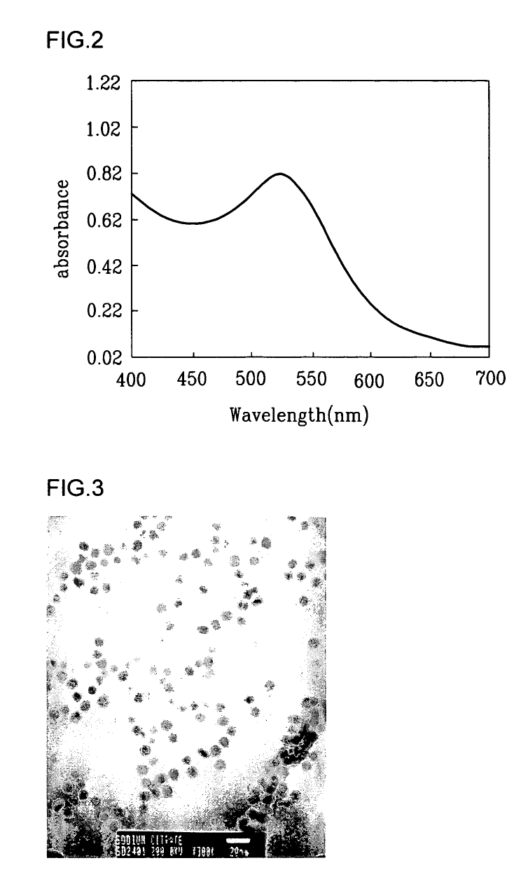

The gold colloid dispersion obtained as a result of the reaction exhibits a maximum absorbance at 524 nm as shown in FIG. 2. The gold colloid particles have a size ranging 9 to 10 nm and a spherical particle shape as shown in FIG. 3.

### 1-2 Preparation of Coating Composition for Forming Gold Thin Layer

1 weight % of a gold chloride aqueous solution was prepared by adding HAuCl₄.3H₂O to demineralized water. A reducing agent-containing solution was prepared by adding 8 mM of NH₂OH.HCl to demineralized water.

### 1-3 Preparation of a Substrate for Immobilizing Physiological Material

A washed slide glass (25×75 mm) was dipped in a 0.05% solution for 10 minutes then washed in ethanol for 10 minutes while agitating the glass, after which the glass was dried under nitrogen atmosphere. The substrate was dipped for 15 minutes in the gold colloid dispersion prepared in the step 1-1 to form a seed colloid catalytic layer. The substrate on which the seed colloid catalytic layer was formed was dipped in a reaction vessel containing 0.5 ml of the gold chloride aqueous solution and 15 ml of the reducing agent-containing solution prepared in the step 1-2 to form a gold thin layer.

### COMPARATIVE EXAMPLE 1

A gold thin layer was formed on a glass substrate using SRH-820 sputtering equipment manufactured by ULVAC Company.

### COMPARATIVE EXAMPLE 2

A washed slide glass (25×75 mm) was dipped in a 1% aminopropyltriethoxy silane (APTES) solution for 10 minutes and then dried under nitrogen atmosphere. The substrate was dipped for 15 minutes in the gold colloid dispersion prepared in the step 1-1 to form a seed colloid catalytic layer. The substrate on which the seed colloid catalytic layer was formed was dipped in a reaction vessel including 0.5 ml of the gold chloride aqueous solution and 15 ml of the reducing agent-containing solution prepared in the step 1-2 to form a gold thin layer.

### COMPARATIVE EXAMPLE 3

A Cr inorganic linker layer was formed to a thickness of 2 nm on a glass substrate and then a gold thin layer was formed on the Cr inorganic linker layer using SRH-820 sputtering equipment manufactured by ULVAC Company.

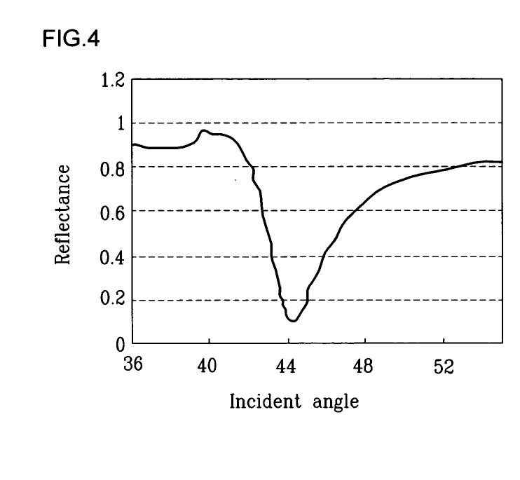

An SPR spectrum of the substrate prepared according to Example 1 was measured using an SPR spectrometer manufactured by Optrel GBR, Federal Republic of Germany, the results of which are shown in FIG. 4. As shown in FIG. 4, a distinct SPR peak appears in the graph. This indicates that the substrate of the present invention can be analyzed through optical analysis equipment.

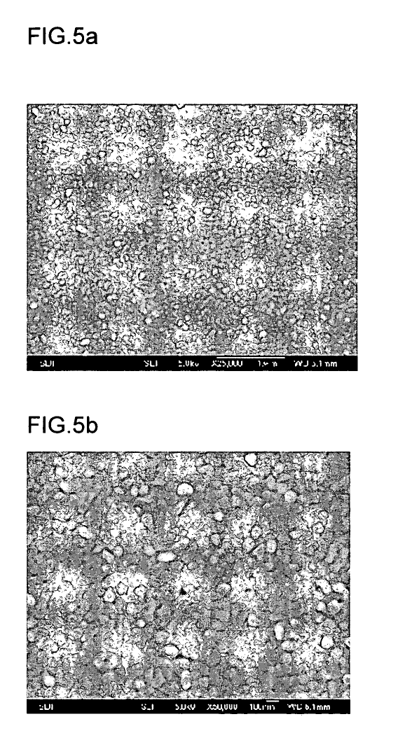

SEM photographs of the gold thin layer prepared according to Example 1 are shown in FIGS. 5a and 5b. As shown in FIGS. 5a and 5b, grain regions that were grown from the metal colloid seed layer were formed on the gold thin layer, indicating that the gold thin layer was grown seed colloid.

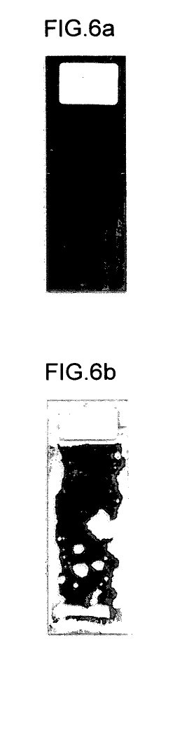

In order to evaluate the attachment strength of the gold substrates according to the Example and Comparative Examples, an acid/base washing test, an ultrasonic washing test, and a peel test were performed. In the acid/base washing test, each of the gold substrates was washed for 20 minutes with a 1M HCl aqueous solution and for 20 minutes with a 1M NaOH, then the amount of gold detached from the substrates was measured. The substrates of Example 1 and Comparative Example 2 after the acid/base washing test are shown in FIGS. 6a and 6b, respectively. As shown in FIG. 6a, the gold substrate according to Example 1 had no areas where the gold became detached from the substrate, whereas as shown in FIG. 6b, there were many such areas on the gold substrate according to Comparative Example 2. In the ultrasonic washing test, ultrasonic waves having a frequency of 40 kHz were applied to the gold substrates at room temperature. There were no areas where the gold became detached in the gold substrate according to Example 1, indicating that the gold was securely attached to the substrate. On the other hand, with the gold substrate according to Comparative Example 2, a portion of the gold substrate was damaged by the ultrasonic waves.

In the peel test, a piece of SCOTCH® brand adhesive tape (manufactured by 3M company) with the dimensions of 1.5 cm×1.5 cm was attached to the gold substrates, then the amount of gold attached on the adhesive tape after the tape was peeled from the substrate was evaluated to measure attachment strength. The adhesive tape was peeled off the substrate at a speed of 0.5 cm/s. Table 1 below shows the results of the peel test for the gold substrate prepared by using PEIM (Example 1), the gold substrate using sputtering deposition (Comparative Example 1), and the gold substrate using aminosilane (Comparative Example 2). Peeling levels appearing in Table 1 were measured as follows: the 1.5 cm×1.5 cm adhesive tape was divided into 25 columns spaced at intervals of 0.3 cm, and the number of columns in which gold was attached was counted. This number as a percentage of the total number of columns was then calculated. The final results are an average value of 10 such tests.

TABLE 1

| | | Comparative | Comparative |
|---|---|---|---|
| | Example 1 | Example 1 | Example 2 |
| Peeling level | 2% | 5% | 10% |

As indicated in Table 1, the attachment strength of the gold substrate of Example 1 comprising the organic polymer PEIM linker material layer was improved.

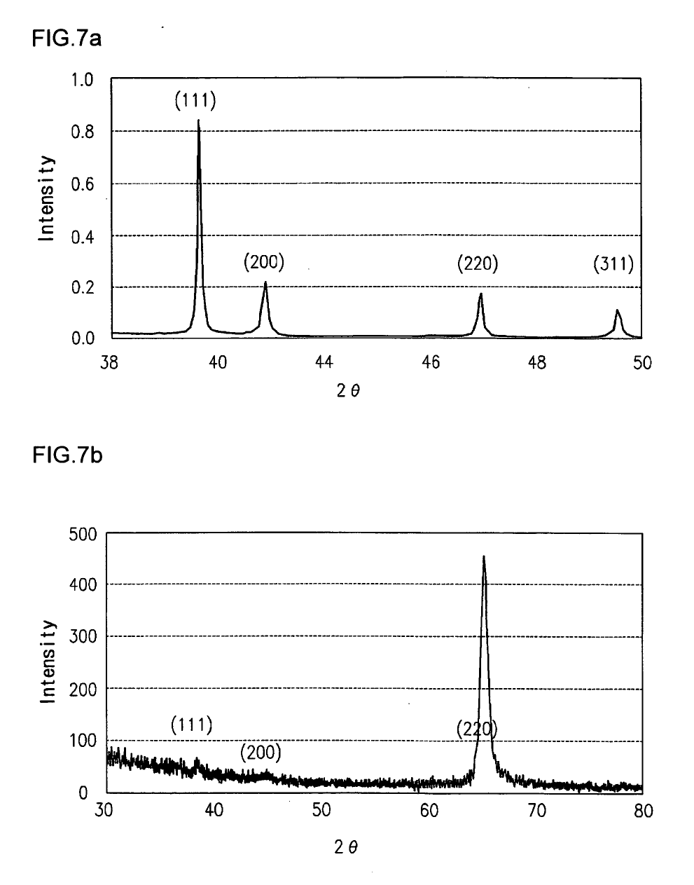

XRD analysis was performed at a scanning rate of 0.02 degrees/second using a Cu target with respect to the gold thin layers of Example 1 and Comparative Example 1. The resolution of the detector was 0.037 degrees and CuKa was used for X-ray radiation. The analysis results are shown in FIGS. 7a and 7b.

As shown in FIG. 7a, the gold thin layer of Example 1 exhibits predominant crystalline phase peaks at 111 and 200 planes. On the other hand, the gold thin layer of Comparative Example 1, with reference to FIG. 7b, exhibits a predominant crystalline-phase peak at 220 plane which is different from that of Example 1. The substrate of the present invention for immobilizing physiological material can be manufactured at a low cost, without requiring investment in high-cost equipment such as vacuum deposition equipment. Further, the organic polymer linker material does not inhibit electron transfer on gold surfaces, enhances attachment strength, and does not deteriorate the electronic and chemical properties of the gold thin layer.

What is claimed is:

1. A substrate construction for immobilizing a physiological material comprising:
a substrate;
an organic polymer linker material layer formed on the substrate; and
a gold thin layer formed on the organic polymer linker material layer, wherein the organic polymer linker material layer has a thickness ranging from 30 to 200 nm and shows peaks of 111 and 200 planes using X-ray diffractometry when the X-rays radiate at an incident angle of 1.5.

2. The substrate construction according to claim 1, wherein the substrate is selected from the group consisting of glass, polycarbonate, polyester, polyethylene, polypropylene, and wafer.

3. The substrate construction according to claim 1, wherein one terminal end of the organic polymer linker material has a functional group that is capable of reacting with a functional group of the substrate and another terminal end has a functional group with a positive charge that is capable of undergoing ionic interaction with a negative charge of a gold colloid surface.

4. The substrate construction according to claim 1, wherein the organic polymer linker material is represented by the formula:
X—R₁—Si(R₂)₃
where X is a functional group having a positive charge that is capable of undergoing ionic interaction with a negative charge of a gold colloid surface, R₁ is a spacer of (CH₂)ₙ or (CH₂)ₙ having one or more carboxyl or imino groups replacing one or more of the ethylene monomers, where n is an integer from 1 to 8, and Si(R₂)₃ is a functional group that is capable of reacting with functional groups on the substrate surface where each R₂ is independently selected from the group consisting of alkoxy groups, halides, and aldehyde groups.

5. The substrate construction according to claim 1, wherein the functional group with a positive charge is an imine group.

6. The substrate construction according to claim 5, wherein the functional group with a positive charge is a functional group having at least two imine groups.

7. The substrate construction according to claim 3, wherein the organic polymer linker material is selected from the group consisting of a viologen-based compound having a formula selected from (2a), (2b) and (2c), a polymer having an imine group-containing polyethylene backbone having formula (3), a compound having formula (4) and a compound having formula (5): 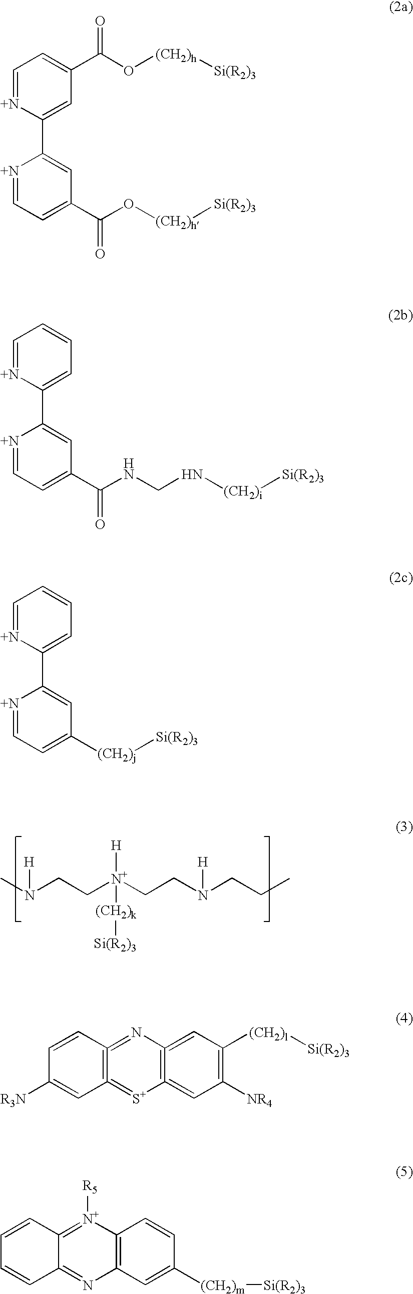
where each R₂ is independently selected from the group consisting of alkoxy groups, halides, and aldehyde groups; h, h′, l and m are integers from 1 to 8; R₃ and R₄ are independently (R₆)₂ where R₆ is a halogen or a C₁ to C₆ alkyl; and R₅ is a halogen or a C₄ to C₆ alkyl.

8. The substrate construction according to claim 7, wherein the organic polymer linker material is selected from the group consisting of a compound having a formula selected from (2a′), (2b′) or (2c′), a polymer having formula (3′), a methylene bule compound having formula (4′) and a phenazine methosulphate compound having formula (5′): 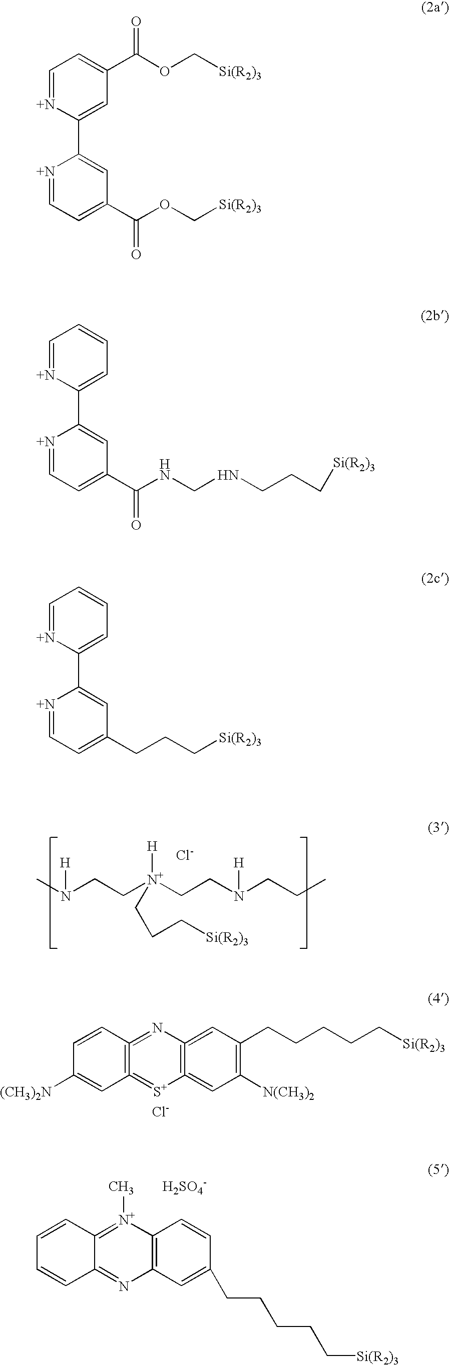
where each R₂ is independently selected from the group consisting of alkoxy groups, halides and aldehyde groups.

9. The substrate construction according to claim 6, wherein the organic polymer linker material comprises trimethoxysilylpropyl polyethyleneimine.

10. A biochip comprising a physiological material immobilized on a surface of the substrate according to claim 1.

11. A biochip according to claim 10, wherein the physiological material is selected from the group consisting of enzymes, proteins, DNA, RNA, microbes, microorganisms, animal and plant cells and organs, and neurons.

12. A method of fabricating a substrate construction for immobilizing a physiological material comprising:
forming an organic polymer linker material layer by coating a coating composition including organic polymer linker material on a substrate;
forming a seed colloid catalytic layer by coating a gold colloid dispersion on the organic polymer linker material layer;
drying or heat-treating the substrate on which the seed colloid catalytic layer is formed; and
applying a coating composition comprising a gold salt-containing aqueous solution and a reducing agent-containing solution to form a gold thin layer.

13. The method according to claim 12, wherein one terminal end of the organic polymer linker material has a functional group that is capable of reacting with a functional group of the substrate and another terminal end has a functional group with a positive charge that is capable of undergoing ionic interaction with a negative charge of a gold colloid surface.

14. The method according to claim 12, wherein the organic polymer linker material is represented by the formula:
X—R₁—Si(R₂)₃
where X is a functional group having a positive charge that is capable of undergoing ionic interaction with a negative charge of a gold colloid surface, R₁ is a spacer of (CH₂)ₙ or (CH₂)ₙ having one or more carboxyl or imino groups replacing one or more of the ethylene monomers, where n is an integer from 1 to 8, and SiR₂ is a functional group that is capable of reacting with functional groups on the substrate surface where each R₂ is independently selected from the group consisting of alkoxy groups, halides, and aldehyde groups.

15. The method according to claim 13, wherein the functional group with a positive charge is an imine group.

16. The method according to claim 13, wherein the organic polymer linker material is selected from the group consisting of a viologen-based compound having a formula selected from (2a), (2b) and (2c), a polymer having an imine group-containing polyethylene backbone having formula (3), a compound having formula (4) and a compound having formula (5): 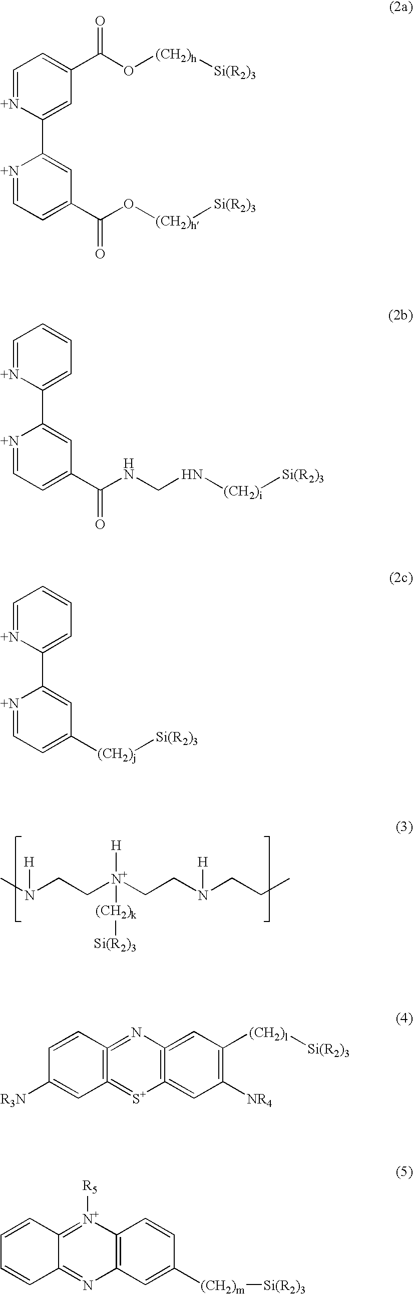
where each R₂ is independently selected from the group consisting of alkoxy groups, halides, and aldehyde groups; h, h′, l and m are integers from 1 to 8; R₃ and R₄ are independently (R₆)₂ where R₆ is a halogen or a C, to C₆ alkyl; and R₅ is a halogen or a C₄ to C₆ alkyl.

17. The method according to claim 16, wherein the organic polymer linker material is selected from the group consisting of a compound having a formula selected from (2a′), (2b′) and (2c′), a polymer having formula (3′), a methylene bule compound having formula (4′) and a phenazine methosulphate compound having formula (5′): 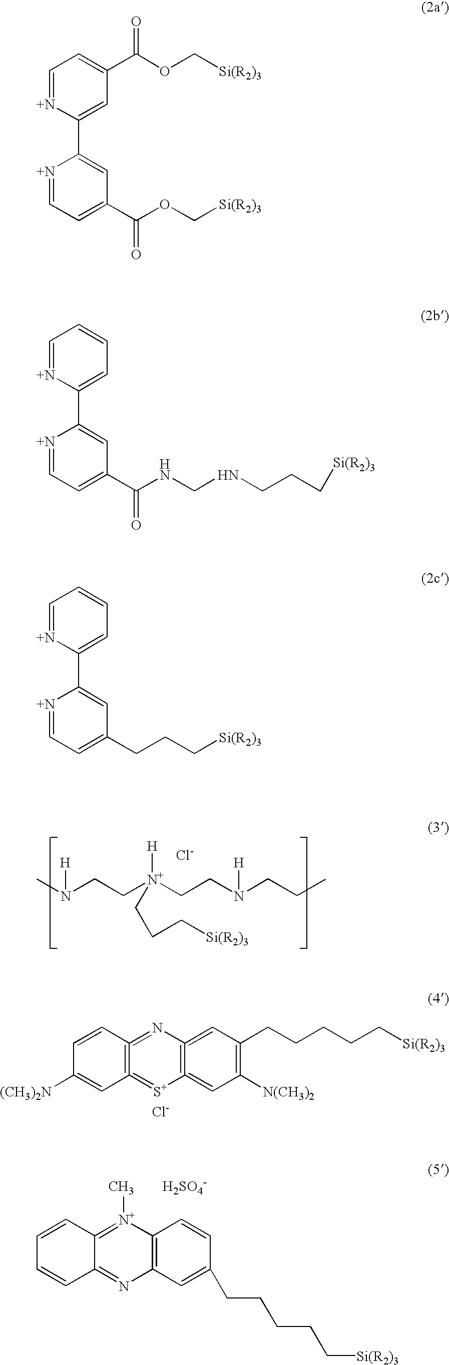
where each R₂ is independently selected from the group consisting of alkoxy groups, halides and aldehyde groups.

18. The method according to claim 13, wherein the organic polymer linker material comprises trimethoxysilylpropyl polyethyleneimine.

19. The method according to claim 12, wherein the organic polymer linker material is used in an amount of 0.01 weight % to 50 weight % based on the coating composition.

20. The method according to claim 12, wherein the organic polymer linker material is coated using a coating method selected from the group consisting of self-assembly thin layer coating, spin-coating, dipping, spraying, printing, and a Langmuir Blodgett Technique.

21. The method according to claim 12, wherein the seed colloid catalytic layer comprises gold colloid having a particle size ranging 5 nm to 500 nm.

22. The method according to claim 12, wherein the gold colloid dispersion comprises gold salt, a reducing agent, a stabilizer and a solvent.

23. The method according to claim 22, wherein the gold salt is selected from the group consisting of HAuCl₄, NaAuCl₄, and mixtures thereof.

24. The method according to claim 22, wherein the reducing agent is selected from the group consisting of NaBH₄, thiocyanate, potassium carbonate, trisodium citrate or hydrate thereof, tannic acid, hydroxyamine or a salt thereof, and mixtures thereof.

25. The method according to claim 22, wherein the stabilizer comprises sodium citrate.

26. The method according to claim 12, wherein the coating method of the seed catalytic layer is selected from the group consisting of dipping, spraying, spin-coating, and printing.

27. The method according to claim 12, wherein the gold salt-containing aqueous solution comprises a gold salt selected from the group consisting of HAuCl₄, NaAuCl₄, and mixtures thereof.

28. The method according to claim 12, wherein the gold salt-containing aqueous solution comprises 0.01 weight % to 20 weight % of a gold salt.

29. The method according to claim 12, wherein the reducing agent of the reducing agent-containing solution is selected from the group consisting of NaBH₄, thiocyanate, potassium carbonate, trisodium citrate or hydrate thereof, tannic acid, hydroxyamine or a salt thereof, and mixtures thereof.

30. The method according to claim 12, wherein the reducing agent-containing solution comprises 0.01 mM to 1M of a reducing agent.

31. The method according to claim 30, wherein the reducing agent-containing solution comprises 0.01 mM to 100 mM of a reducing agent.

32. The method according to claim 12, wherein the coating of the gold thin layer is performed using a plating method.
